(19) United States
(12) Patent Application Publication
(10) Pub. No.: US 2007/0183839 A1
(43) Pub. Date: Aug. 9, 2007

(54) Bound component with adjustable elastic device

(76) Inventors: Thomas Scott Walker, Kettering, OH (US); Kevin Wesley Witter, Dayton, OH (US)

Correspondence Address: THOMPSON HINE L.L.P.;Intellectual Property Group, P.O. BOX 8801, DAYTON, OH, 45401-8801, US

(21) Appl. No.: 11/600,943

(22) Filed: Nov. 16, 2006

Related U.S. Application Data
(60) Provisional application No. 60/737,082, filed on Nov. 16, 2005.

(51) Int. Cl. B42F 13/04

(52) U.S. Cl. 402/57

(57) ABSTRACT

A bound component including a cover having a retaining device located thereon and a binding mechanism coupled to the cover and configured to bind a plurality of pages together. The bound component further includes an elastic strap, the elastic strap being formed in a loop or formable into a loop. The retaining device is configured to cooperate with the elastic strap to slidably couple the elastic strap to the cover and to limit the sliding motion of the elastic strap relative to the cover when the elastic strap is formed in a loop.

This application claims priority to U.S. Provisional Application Ser. No. 60/737,082, filed on Nov. 16, 2005, the entire contents of which are hereby incorporated by reference.

The present invention is directed to a bound component, and more particularly, to a bound component including an adjustable elastic device, such as a loop or strap.

### BACKGROUND

Bound components, such as notebooks, binders, journals, planners, notepads, address books, etc. are widely used as a source of paper, and as a device for storing loose components. However, existing bound components may have a limited capacity for storing loose components. In addition, existing bound components may lack efficient closure structures, as well as placeholding structures. Accordingly, there is a need for a bound component with improved features.

### SUMMARY

In one embodiment, the present invention is a bound component with an adjustable elastic device. The adjustable elastic device may be able to store loose components, and/or operate as a closure structure, and/or operate as a placeholder. In one embodiment, the invention is a bound component including a cover having a retaining device located thereon and a binding mechanism coupled to the cover and configured to bind a plurality of pages together. The bound component further includes an elastic strap, the elastic strap being formed in a loop or formable into a loop. The retaining device is configured to cooperate with the elastic strap to slidably couple the elastic strap to the cover and to limit the sliding motion of the elastic strap relative to the cover when the elastic strap is formed in a loop.

### BRIEF DESCRIPTION OF THE DRAWINGS

FIG. 1 is a front perspective view of one embodiment of the bound component of the present invention, illustrating the elastic device in a first position;

FIG. 2 is a front perspective view of the bound component of FIG. 1, with the elastic device moved to a second position;

FIG. 3 is a front perspective view of the bound component of FIG. 1, with the ends of the elastic device separated;

FIG. 4 is a front perspective view of the bound component of FIG. 1, with the bound component opened and the elastic device slid to a middle position and coupling a book to an inner surface of the bound component;

FIG. 5 is a front perspective view of the bound component of FIG. 1, with the elastic device slid to the middle position and receiving a set of books therein;

FIG. 6 is a front perspective view of the bound component of FIG. 4, with the book removed and the elastic device receiving a set of papers therein and acting as a placeholder;

FIG. 7 is an end view of the bound component of FIG. 6 in its closed position;

FIG. 8 is a front perspective view of the bound component of FIG. 1, with the. elastic device moved to the middle position and extending around the front and rear covers thereof;

FIG. 9 is an end view of the bound component of FIG. 8;

FIG. 10 is a front perspective view of another embodiment of the bound component of the present invention; and

FIG. 11 is a front perspective view of another embodiment of the bound component of the present invention, utilizing an elastic device with permanently attached ends.

### DETAILED DESCRIPTION

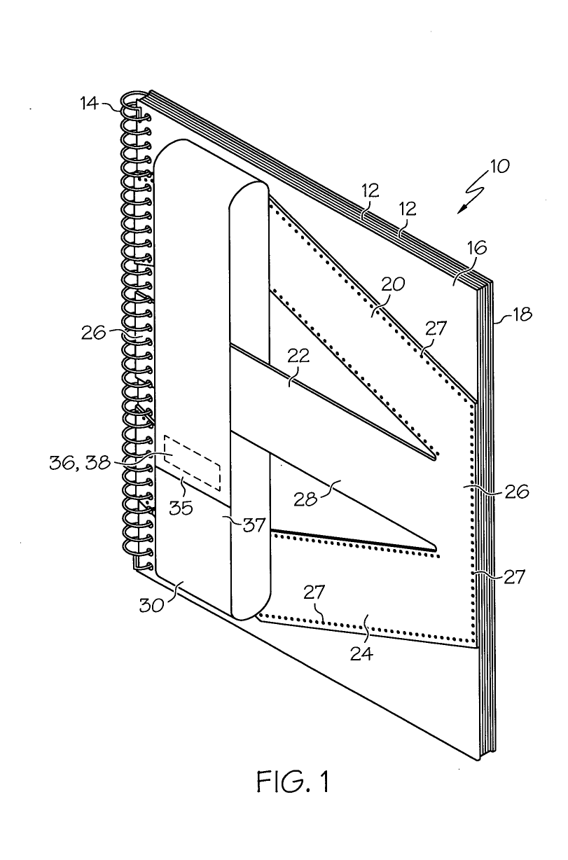

As shown in FIG. 1, the present invention may take the form of a bound component 10 such as a notebook, binder journal, planner, notepad, address book or the like. The bound component 10 includes a plurality of bound pages or sheets 12 that are bound together by a binding mechanism 14. The bound component 10 may include a front cover 16 and a back cover 18 that can be positioned on either side of the sheets 12, as shown in FIG. 1, to protect the sheets 12. Each cover 16, 18 can have a stiffness or thickness greater than each of the bound pages 12 to provide protection to the pages 12. For example, the covers 16, 18 can be made of cardboard, paperboard, plastic or the like, and may have generally the same size and shape as the bound pages 12 or be slightly larger thereof.

The binding mechanism 14 binds the front cover 16, back cover 18 and the bound pages 12 together. In the illustrated embodiment, the binding mechanism 14 is a coil binding mechanism. However, it should be understood that the binding mechanism 14 can take any of a variety of forms, including but not limited to spiral binding mechanisms, three-ring binders, book-style or adhesive binding mechanisms, prongs, clips, etc. Each bound page 12 may be made of a generally water absorbent material such as cellulose or pulp-based paper to allow a user to write information thereon with a wide variety of writing instruments, including pens, pencils, markers and the like.

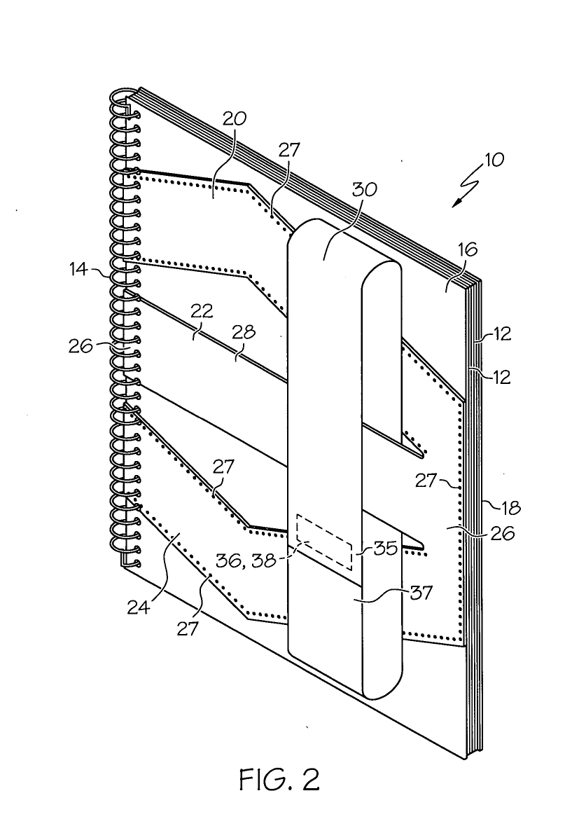

In the illustrated embodiment, the front cover 16 includes an upper strip 20, middle or retaining strip 22 (also termed a retaining device herein), and a lower strip 24 permanently or fixedly affixed to the front cover 16. The strips 20, 22, 24 can be made of a variety of materials, such as plastic, cardboard, paperboard, fabric or the like. In the illustrated embodiment, the strips 20, 22, 24 are formed from a single piece of material, although if desired the strips 20, 22, 24 can be made of separate pieces of material. The retaining strip 22 may extend in a generally horizontal, left-to-right direction (i.e. generally perpendicular to the binding mechanism 14) on the front cover 16, and the other strips 20, 24 may extend generally parallel to the retaining strip 22. As shown in FIGS. 1 and 2 the strips 20, 22, 24 may be located and arranged as to define a recognizable shape, such as a number, letter, symbol or the like. In the illustrated embodiment, the recognizable shape is generally in the form of the letter “M” or “W” rotated 90°.

In the illustrated embodiment the upper 20 and lower 24 strips are coupled to the front cover 16 along both longitudinal edges thereof, and generally along both vertical edges thereof (as can be seen by the welding dots 27). In the illustrated embodiment the outermost or vertical edges 26 of the retaining strip 22 are directly coupled to the front cover 16, and the longitudinal edges of strip 22 are not coupled to the front cover 16. In the illustrated embodiment the inner vertical edge 26 is coupled to the front cover 16 by the binding mechanism 14 which passes through openings in the inner vertical edge 26; and the outer vertical edge 26 is coupled by the welding dots 27. Thus, in this case the center portion 28 of the retaining strip 22 is movable away from the front cover 16. The strips 20, 22, 24 can be coupled to the front cover 16 by any of a variety of methods, including but not limited to heat welding, permanent adhesives, sonic welding, stitching or the like.

As shown in FIG. 1, an elastic loop, elastic strap or elastic device 30 may be wound around the retaining strip 22 such that part of the elastic loop 30 is positioned between the front cover 16 and the retaining strip 22. The elastic loop 30 may be freely moveable in the left to right direction (i.e. in a generally perpendicular direction to the binding mechanism 14) within the dimensional constraints of the center portion 28/retaining strip 22, as can be seen by comparing FIGS. 1 and 2. The retaining strip 22 limits the sliding motion of the elastic loop 30 such that at least part of the elastic loop 30 remains positioned within the outer perimeter of the front cover 16. The retaining strip 22 can also be used to ensure that the loop 30 remains attached to the bound component 10, to ensure that the loop 30 does not become inadvertently separated or lost.

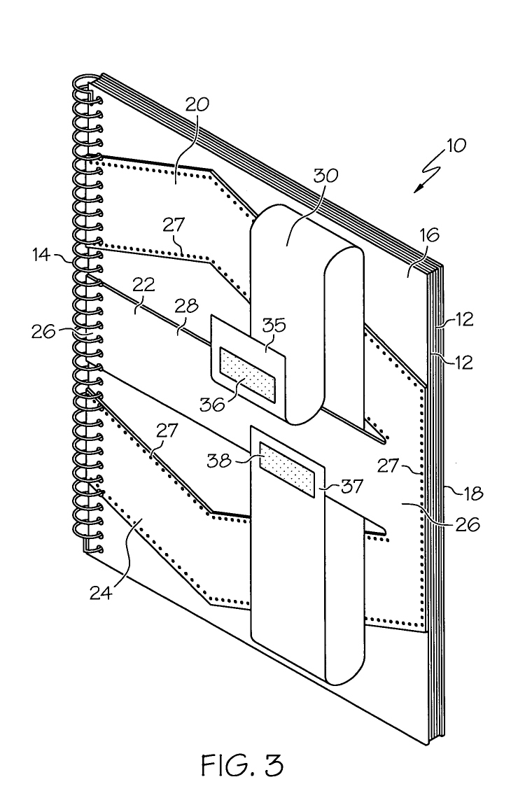

In the embodiment shown in FIGS. 1-10, the elastic loop 30 is removably coupled to the bound component 10. For example, as best shown in FIG. 3 the elastic loop 30 may have a pair of ends 35, 37. Each end 35, 37 has an associated patch of hook-and-loop fastening material 36, 38 (such as VELCRO®) located thereon to act as an attachment mechanism and releasably couple the ends 35, 37 together to form a closed loop. The ends 35, 37 of the elastic loop 30 may be releasably coupled together by any of a variety of other attachment mechanisms besides hook-and-loop material, such as buttons, snaps, hooks, clasps, magnets, or the like, although the hook-and-loop material is easy to operate and allows the ends 35, 37 to be coupled together in various overlapping states. The elastic loop 30 may be coupled to the front cover 16 by passing the loop 30 under the retaining strip 22 and then affixing the ends 35, 37 together. A lower portion of the elastic loop 30 may be positioned between the retaining strip 22 and the cover 16 such that the retaining strip 22 securely couples the elastic loop 30 to the cover 16.

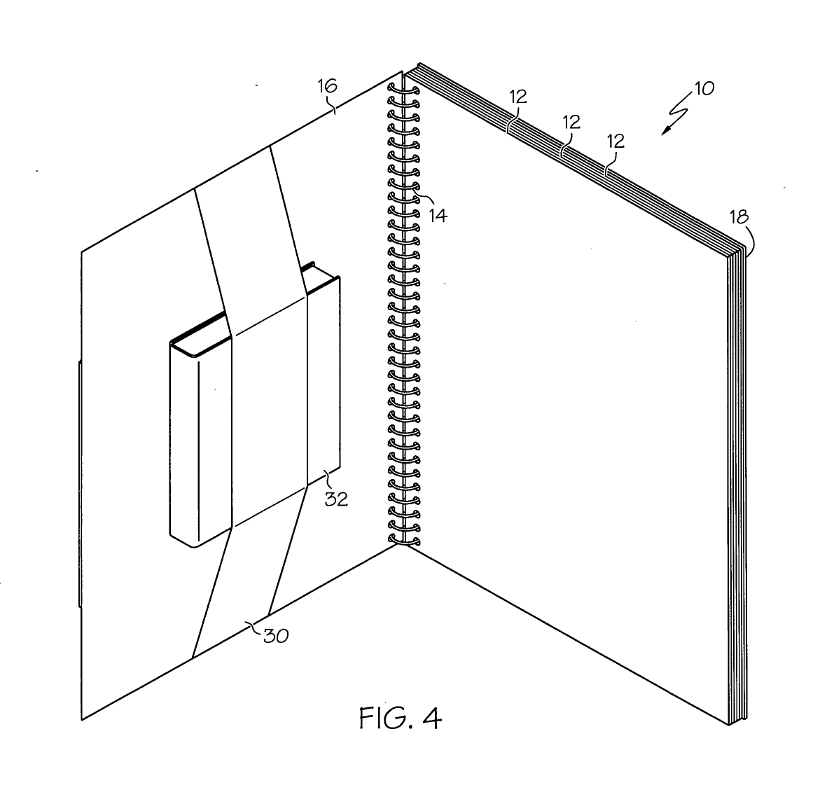

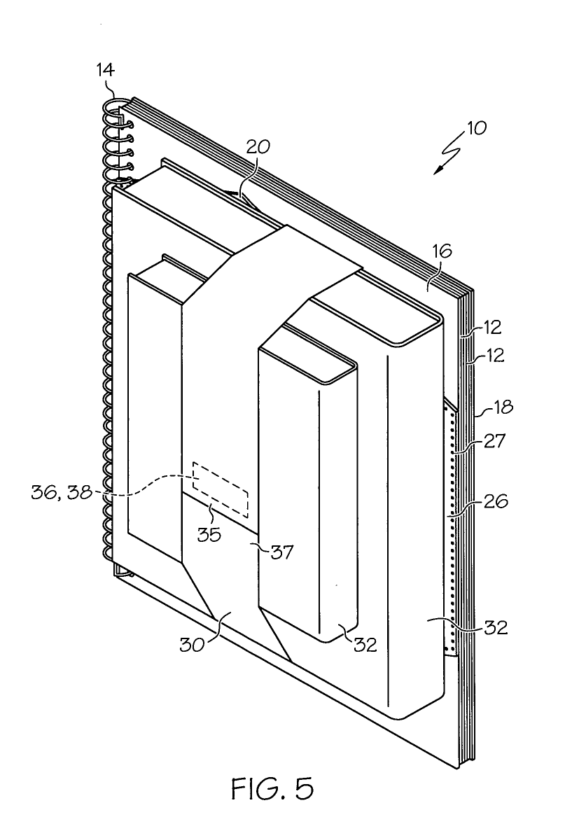

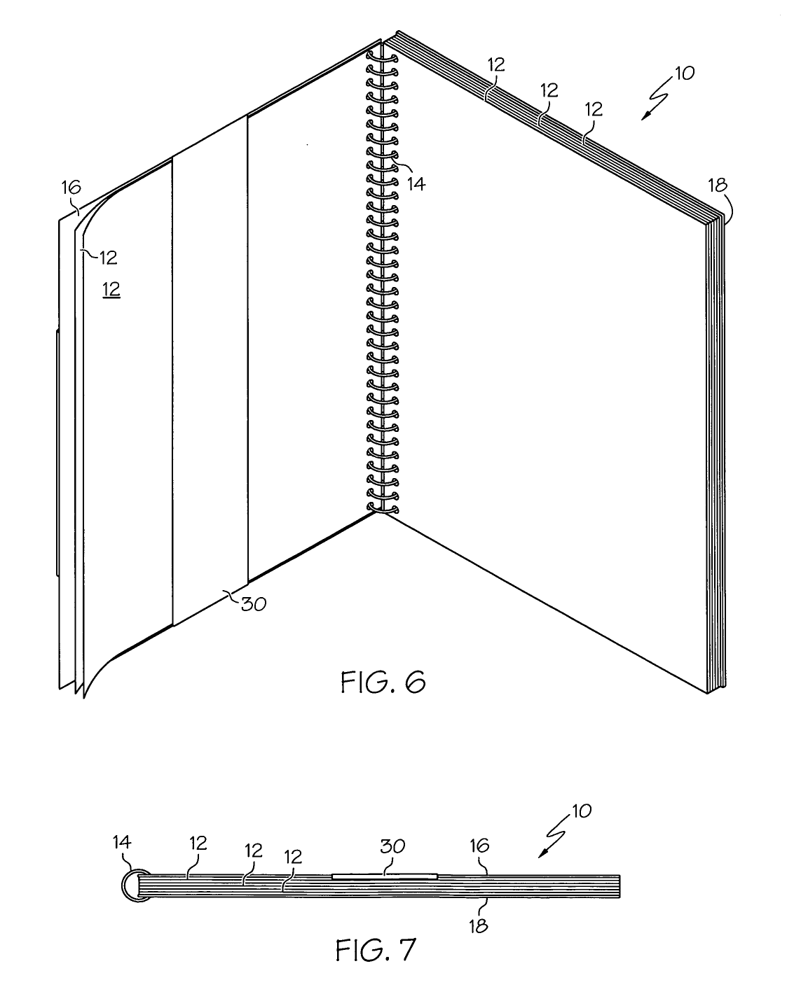

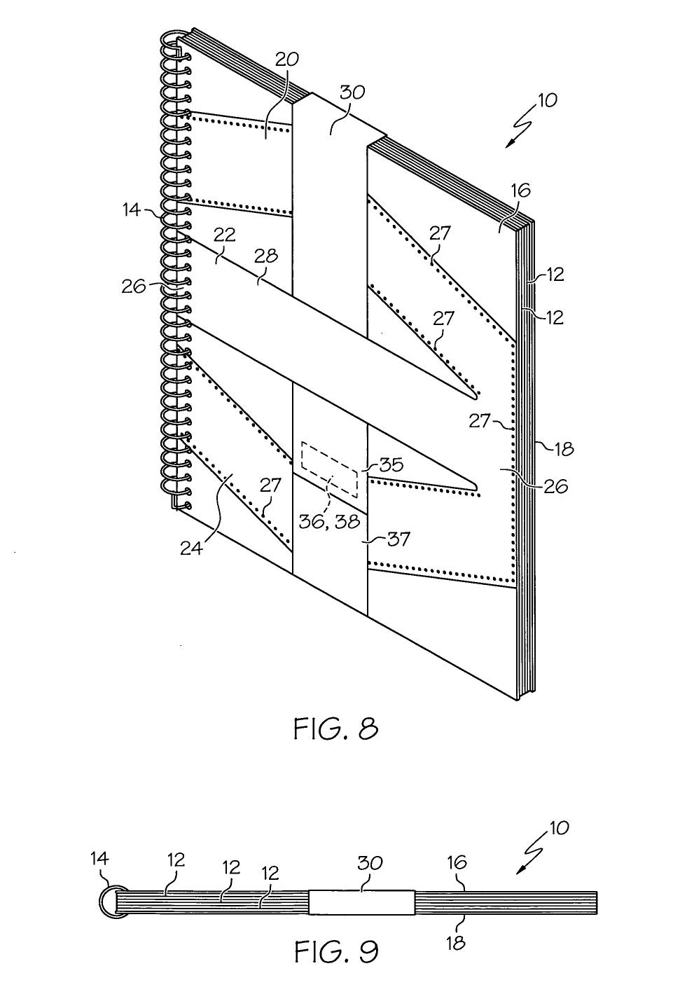

The elastic loop 30 may be made of a generally stretchable material which may be extended (i.e. at least about 10% in a given direction) when stretching forces are applied, and will sustain this extended shape until the stretching forces are removed, and thereafter will return to its original shape. The elastic loop 30 may be made of various materials such as natural rubbers, synthetic rubbers, elastomeric plastics, woven or braided fabrics containing elastic fibers, etc., or combinations of these materials, and may be made entirely of elastic material around the entire length/perimeter thereof. The elastic nature of the loop 30 allows the loop 30 to expand sufficiently to receive loose components 32 therein (FIGS. 4 and 5), or to operate as a placeholder (FIGS. 6 and 7), or to operate as a closure device (FIGS. 8 and 9), as will be described in greater detail below.

The elastic loop 30 may have a width of between about ½ inches to about 4 inches, and more particularly between about 1 inches and about 3 inches. The elastic loop 30 may have a width that is at least about 1/10 of the width of the front cover 16, or at least about ⅛ of the width of the front cover 16, or less than about ½ of the width of the front cover 16. Thus, the loop 30 may have a sufficient width to allow the loop 30 to stably grip loose components 32 therein (FIGS. 4 and 5), to operate as a placeholder without tearing pages (FIGS. 6 and 7) and to operate as a closure device (FIGS. 8 and 9) and avoid twisting, but should not be so wide as to be unwieldy and difficult to manipulate and use. The elastic loop 30 may have a height about equal to the height of the front cover 16.

In one embodiment of the invention, as shown in FIG. 4, the elastic loop 30 may be used to frictionally grip and to secure loose items or component 32 (e.g., books, papers, markers, notepads, calendars, pencils, etc.) to the inner surface of the front cover 16. In the embodiment shown in FIG. 4 the elastic loop 30 is configured such that the elastic loop 30 extends around the front cover 16, and does not extend around the pages 12 or back cover 18. In the configuration shown in FIG. 4, the elastic loop 30 can also secure loose items to the outer surface of the front cover 16 by trapping items between the loop 30 and the outer surface of the front cover 16. The elastic loop 30 may be positioned either under, or on top of, the retaining strip 22.

As shown in FIG. 5, the elastic loop 30 can receive and secure loose items 32, even when the loop 30 does not extend around the front cover 16, or rear cover 18, or pages 12. In this case, the loose components 32 are held entirely in place by the loop 30 and are not trapped between the loop 30 and the front cover 16. In this case the elastic loop 30 is passed around/under the retaining strip 22. This configuration allows a user to bind loose components 32 together without extending the loop 30 around the front cover 16, in case, for example, the inner surface of the front cover 16 is already being used or is inaccessible (i.e., post-it notes are attached to the inner surface of the front cover 16, or the inner surface includes a pouch or other feature).

In order to open the elastic loop 30, the ends 35, 37 of the elastic loop 30 are manually pulled apart to separate the hook and loop fastening material 36, 38. If desired, the elastic loop 30 can be opened, and the loose components 32 can be placed on top of the elastic loop 30. The elastic loop 30 can then be stretched and the ends 35, 37 pressed together to secure the loose component 32 in the elastic loop 30. Alternately, the elastic loop 30 can be stretched into a larger loop 30 (i.e. while the ends 35, 37 remain attached), and the loose component 32 inserted into the enlarged loop 30. The loop 30 is then allowed to contract around the loose components 32. Thus a wide variety of loose items 32 having varying dimensions may be secured to the bound component 10 by the elastic loop 30 in varying manners.

As shown in FIGS. 6 and 7 the elastic loop 30 may be wrapped around a plurality of bound pages 12 at various locations thereof to operate as a placeholder. In this case, the elastic loop 30 extends through the stack of pages 16 at a partial depth thereof to mark a predetermined location (see FIG. 7). If desired, loose items 32 can be coupled to the outer surface of the front cover 16 by the elastic loop 30 when the elastic loop 30 is in the configuration shown in FIGS. 6 and 7. The elastic loop 30 may be positioned either under, or on top of, the retaining strip 22.

The elastic loop 30 may also function as a closure device for the bound component 10 as shown in FIGS. 8 and 9. In this configuration the elastic loop 30 may be expanded and passed around substantially the entire bound component 10 (i.e. the plurality of bound pages 12, the front cover 16 and the back cover 18) in a generally vertical direction. (i.e. generally parallel to the binding mechanism 14) to secure the bound component 10 in its closed position. In the illustrated embodiment, the elastic loop 30 is configured generally vertically and circumscribes the notebook 10 in a top to bottom direction. In addition, in the embodiment illustrated in FIG. 8 the elastic loop 30 extends below the strip 22; however, if desired, the elastic loop 30 can be positioned on top of the strip 22.

In addition, the elastic loop 30 can be uncoupled from and separated from the bound component 10 when its use is not desired by separating the ends 35, 37. This configuration also allows the elastic loop 30 to be used as a stand-alone component separate and apart from the bound component 10.

It should be understood that the elastic loop 30 can be positioned at a variety of locations on the bound component 10. For example, rather than being located on the front cover 16 and affixed to the retaining strip 22, the elastic loop 30 may be located on the back cover 18, and could also be fastened to the strip 20 or the strip 24 in same or a similar manner as described herein. In addition, the strips 20, 24 are optional and need not necessarily be utilized. Furthermore, the strips 20, 22, 24 may be located at a variety of locations on the bound component 10, such as front cover 16, back cover 18, both covers 16, 18, etc.

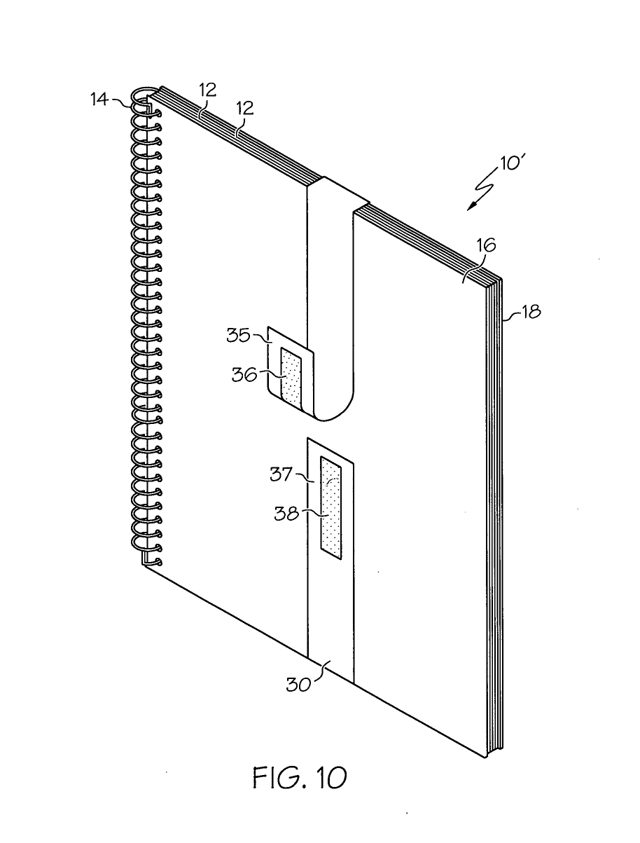

As shown in FIG. 10, the elastic loop 30 may be used in conjunction with a notebook or bound component 10′ that does not include any of the strips 20, 22, 24. In this case the elastic loop 30 can be used to couple loose components to the front 16 or rear 18 covers, used as a placeholder, or used as a closure device. However, in this embodiment the lateral movement of the elastic loop 30 is not constrained, and the elastic loop 30 is not necessarily coupled to the front cover 16 by strip 22.

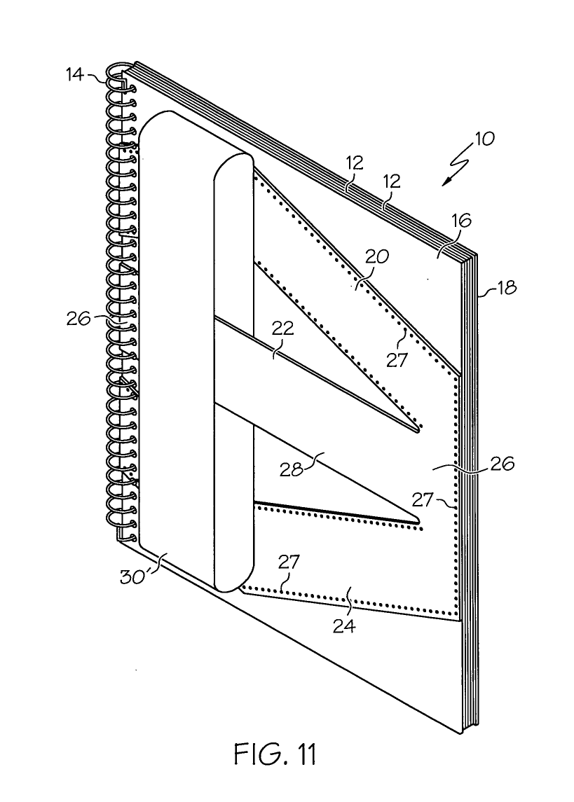

In yet another embodiment shown in FIG. 11, the ends of the loop 30 may be permanently attached together, such as by stitching, permanent adhesives, heat welding, sonic welding, permanent mechanical fixtures or the like to form a continuous, non-removable loop 30′. The elastic loop 30′ of FIG. 11 may have a similar width dimension, height dimension, and material of construction as the elastic loop 30 described above and shown in FIGS. 1-10. The permanently attached ends of the loop 30′ ensure that the elastic loop 30′ does not become separated from the bound component 10.

The elastic loop 30, 30′ need not necessarily extend in a vertical direction (i.e. parallel to the binding mechanism 14), and could instead extend in a horizontal direction (i.e. perpendicular to the binding mechanism 14). Thus, the elastic loop 30, 30′ may be configured to circumscribe the plurality of bound pages 12, and/or the front cover 16 and/or the back cover 18 in a generally left-to-right direction (i.e. the loop 30 may be oriented generally perpendicular to the binding mechanism 14). In this case, the elastic loop 30, 30′ may have a width (i.e. in the left-to-right direction) about equal to the width of the front cover 16. Thus the elastic loop 30, 30′ may be positioned in a variety of configurations to secure the bound component 10 in a closed position in various arrangements.

Having described the invention in detail and by reference to the preferred embodiments, it will be apparent that modifications and variations thereof are possible without departing from the scope of the invention.

What is claimed is:

1. A bound component comprising:
a cover having a retaining device located thereon;
a binding mechanism coupled to said cover and configured to bind a plurality of pages together; and
an elastic strap, said elastic strap being formed in a loop or formable into a loop, wherein said retaining device is configured to cooperate with said elastic strap to slidably couple said elastic strap to said cover and to limit the sliding motion of said elastic strap relative to said cover when said elastic strap is formed in a loop.

2. The bound component of claim 1 wherein when said elastic strap is formed in a loop and is slidably coupled to said cover by said retaining device, said retaining device limits the sliding motion of said elastic loop relative to said cover.

3. The bound component of claim 2 wherein at least part of said elastic loop is positioned between said retaining device and said cover to slidably couple said elastic loop to said cover.

4. The bound component of claim 2 wherein said cover has an outer perimeter, and wherein said retaining device limits the sliding motion of said elastic loop such that at least part of said elastic loop is always positioned within said outer perimeter of said cover.

5. The bound component of claim 2 wherein said elastic loop is positionable such that said elastic loop does not extend around said cover and does not extend around said plurality of pages.

6. The bound component of claim 2 wherein said binding mechanism extends in a first direction, and wherein said elastic loop is slidably coupled to said cover by said retaining device such that elastic loop is slidable relative to said cover in a second direction that is generally perpendicular to said first direction.

7. The bound component of claim 2 wherein said elastic loop has a height dimension that is generally equal to a height dimension of said cover.

8. The bound component of claim 2 wherein said binding mechanism includes a plurality of papers bound thereto, and wherein said elastic loop is positionable to wrap around said cover and all of said plurality of papers to operate as a closure mechanism, and wherein said elastic loop is positionable such that said elastic loop does not wrap around said cover or said pages and loose component are receivable therein such that said elastic loop operates as a storage mechanism, and wherein said elastic loop is positionable such that said elastic loop wraps around said cover and part of said plurality of papers to act as a page marker mechanism.

9. The bound component of claim 1 wherein when said elastic strap is configured such that when said elastic strap is formed in a loop and slidably coupled to said cover by said retaining device, at least part of said elastic loop is positioned between said retaining device and said cover.

10. The bound component of claim 1 wherein when said elastic strap is configured such that when said elastic strap is formed in a loop and slidably coupled to said cover by said retaining device, said elastic loop is positionable in at least the three following distinct configurations: said loop is wrapped around said cover and all of said plurality of papers to operate as a closure mechanism, or said loop is positioned such that said loop does not wrap around said cover or said pages and loose components are receivable therein such that said elastic loop operates as a storage mechanism, or said elastic loop is wrapped around said cover and part of said plurality of papers to act as a page marker mechanism.

11. The bound component of claim 10 wherein said elastic loop is positionable in all three distinct configurations.

12. The bound component of claim 1 wherein said elastic strap has a width that is at least about 1/10 of the width of said cover.

13. The bound component of claim 1 wherein said elastic strap has a width of between about ½ inch and about 4 inches.

14. The bound component of claim 1 wherein said elastic strap is made of natural rubber, or synthetic rubber, or elastomeric plastic, or woven or braided fabrics containing elastic fibers, or combinations of these materials.

15. The bound component of claim 1 wherein said elastic strap is made of a generally stretchable material which may be extended at least about 10% in a given direction when stretching forces are applied, and returns to its original shape when said stretching forces are removed.

16. The bound component of claim 1 wherein said cover including a retaining strip coupled thereto, and wherein a lower portion of said elastic strap is positionable between said retaining strip and said cover such that said restraining strip securely couples said elastic loop to said cover.

17. The bound component of claim 16 wherein said retaining strip is directly coupled to said cover at each opposite ends thereof, and wherein a middle portion of said retaining strip is not directly coupled to said cover such that said elastic loop is slidable along said middle portion.

18. The bound component of claim 16 further comprising a supplemental strip directly coupled to said cover, and wherein said strip extends generally parallel to said retaining strip.

19. The bound component of claim 1 further comprising a supplemental cover coupled to said cover and to said binding mechanism, and wherein pages bound together by said binding mechanism are positionable between said cover and said supplemental cover.

20. The bound component of claim 1 wherein said elastic strap is releasably attachable to itself to form said elastic strap into a loop.

21. The bound component of claim 1 wherein said elastic strap includes an attachment mechanism for releasably attaching said elastic strap to itself to form said elastic strap into a loop.

22. The bound component of claim 21 wherein said attachment mechanism includes patches of hook and loop fastener material.

23. The bound component of claim 1 wherein said elastic loop is made entirely of elastic material around an entire length thereof.

24. The bound component of claim 1 wherein said elastic strap is permanently formed into a loop.

25. A method for using bound component comprising:
providing a bound component including a cover having a retaining device located thereon, a binding mechanism coupled to said cover and configured to bind a plurality of pages together, and an elastic strap, said elastic strap being formed in a loop or formable into a loop, wherein said retaining device is configured to cooperate with said elastic strap to slidably couple said elastic strap to said cover; and
sliding said elastic strap relative to said cover such that said retaining device limits the sliding motion of said elastic strap relative to said cover.

26. A method for using bound component comprising:
providing a bound component including a cover and a binding mechanism for binding a plurality of pages together, and an elastic loop slidably coupled to said cover; and
manipulating said elastic loop to:
wrap around said cover and all of said plurality of papers bound by said binding mechanism to operate as a closure mechanism; or
receive loose components therein to operate as a storage mechanism when said elastic loop is not entirely wrapped around said cover; or
wrap around said cover and part of said plurality of papers to act as a page marker mechanism.

27. The method of claim 26 wherein said manipulating step includes manipulating said elastic loop to:
wrap around said cover and all of said plurality of papers bound by said binding mechanism to operate as a closure mechanism; and
receive loose components therein to operate as a storage mechanism when said elastic loop is not entirely wrapped around said cover; and
wrap around said cover and part of said plurality of papers to act as a page marker mechanism.
